(19) United States
(12) Patent Application Publication
(10) Pub. No.: US 2017/0212763 A1
(43) Pub. Date: Jul. 27, 2017

(54) EXCEPTION HANDLING PREDICATE REGISTER

(71) Applicant: HEWLETTT PACKARD ENTERPRISE DEVELOPMENT LP, Houston, TX (US)

(72) Inventors: King Wayne LUK, Roseville, CA (US); Thomas A. KEAVENY, Roseville, CA (US)

(21) Appl. No.: 15/327,874

(22) PCT Filed: Jul. 25, 2014
(86) PCT No.: PCT/US14/48247

§ 371 Date: Jan. 20, 2017

(51) Int. Cl. G06F 9/38; G06F 9/30

(52) U.S. Cl. CPC G06F 9/3865; G06F 9/30101; G06F 9/30145

(57) ABSTRACT

A predicate register is assigned as an exception handling predicate register. An exception may be detected when executing the machine readable instructions. An exception state for the exception is stored in the exception handling predicate register.

### BACKGROUND

Microprocessors often use instruction pipelining to increase instruction throughput. An instruction pipeline processes several instructions through different stages of instruction execution concurrently, using an assembly line-type approach. Exception handling during execution of instructions provides a standard mechanism for responding to runtime errors. Some examples of errors or conditions that may invoke exception handling include an input argument that is invalid, e.g. value is outside of the domain of a function, or when a resource is unavailable, e.g., a missing file, a hard disk error, or out-of-memory errors.

During program execution, a processor interrupt may be generated when an exception is detected. The exception handling is invoked by the interrupt and may include saving processing states, and the processing is branched to an interrupt service routine to handle the exception instead of proceeding with execution of the instructions in the pipeline. Once the interrupt service routine is completed, the states are restored, and execution of the instructions continues.

### BRIEF DESCRIPTION OF DRAWINGS

Examples of the present disclosure are described in detail in the following description with reference to the following figures.

FIG. 1 illustrates a processor, according to an example;

FIG. 2 illustrates a system, according to an example; and

FIG. 3 illustrates a method for exception notification, according to an example.

### DETAILED DESCRIPTION OF EMBODIMENTS

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. In the present disclosure, the term “includes” means includes but not limited thereto, the term “including” means including but not limited thereto. The term “based on” means based at least in part on. In addition, the terms “a” and “an” are intended to denote at least one of a particular element.

According to an example, a predicate register is used for exception handling and is referred to as an exception handling predicate register. An exception is an anomaly or predetermined special event that occurs during processing of instructions. A common exception is a floating point divide by zero. Another example is an out of memory. Typically these exceptions represent errors that occur during runtime and the exceptions may have to be handled or otherwise considered to continue processing of instructions. Many different types of exceptions are detectable and handled during runtime of a computer program.

When an exception is detected during runtime, such as during execution of machine readable instructions for a computer program, the exception handling predicate register is set. For example, a predetermined value indicating an exception has occurred is stored in the exception handling predicate register. Such indication of an exception state is then available to the computer program, and whether to process or ignore the exception is under control of the program. Since determination of whether to continue execution of the program is under control of the program, in contrast to the traditional interrupt driven approach whereby execution may be suspended and an interrupt service routine is executed, the program can choose to handle the exception, or the program can choose to ignore the exception for higher performance throughput and defer the exception handling at a later point. Predication and predicate registers are further described below.

Predication is the conditional execution of machine readable instructions of a computer program. Predication is used by various processor architectures, such as the IA-64 processor architecture, and the processors, e.g., ITANIUM processors and their predecessors, that implement these architectures. Predication is used to minimize branch prediction penalties. For example, where conditional branches are used in a program to set up a structure, such as if/then/else, the operations in each possible sequence are predicated (made conditional) on the contents of a given predicate register. Operations from both possible paths, such as the “then” and “else” paths, are executed by parallel pipelined execution units in the processor but only one set of operations, i.e., the operations having predicates that evaluate to true, are allowed to write their results. Accordingly, a predicated instruction uses a predicate register storing the predicate as an additional input operand. For example, a Boolean result of a condition testing is recorded in the predicate register for each predicated instruction, e.g., the predicated instructions for the “then” and “else” branches, and a predicated instruction can write its results if the predicate register indicates that the predicate for the predicated instruction evaluates to true. Through this technique, predication may be used to remove branches and maximize parallel execution.

Predicate registers are special purpose registers in a processor that store the predicates for predicated instructions. The predicates are values representing results of condition testing for predicated instructions. Predicate registers are used for example in the processor architectures and types described above that implement predication. In an example, a processor may have a predetermined number of 1-bit, predicate registers that store a 0 or 1 depending on the condition testing for a predicated instruction. For example, a predicated instruction has a predicate register field identifying a particular predicate register. If the identified predicate register stores a value of true, the results of executing the predicated instruction are written for example to the register set in memory, such as registers in random access memory (RAM); otherwise the results are ignored and not written. Predicate registers are special purpose registers in the processor and are separate from the register set in RAM which is typically used to store data for the execution of the computer program, such as results of operations defined in the instructions.

As discussed above, according to an example of the present disclosure, an exception handling predicate register is a predicate register but the exception handling predicate register is used for storing an exception state and exception handling instead of storing a predicate for a predicated instruction. For example, during execution of a computer program, the exception handling predicate register is used to store an exception state indicating whether an exception is detected rather than storing the results of condition testing for a predicated instruction. The exception handling predicate register may be a predicate register that is assigned to store an exception state. In one example a predicate register is dedicated to being an exception handling predicate register and is pre-assigned as the exception handling predicate register prior to running computer programs. In another example, a predicate register is dynamically assigned to be an exception handling predicate register, such as by an instruction in the computer program. For example, the programmer may include an instruction in the computer program that indicates that one or multiple predicate registers are dedicated as exception handling predicate registers. In this example, the predicate register may be assigned as the exception handling predicate register during execution of the computer program and then it is released for normal use as a traditional predicate register. Regardless of how the predicate register is assigned, one or multiple predicate registers may be assigned as exception handling predicate registers.

The exception handling state stored in the exception handling predicate register indicates whether an exception has occurred or not. The exception state may indicate additional information about the exception such as the type of exception. The processor may read the exception state from the exception handling predicate register to determine how to handle the exception, such as whether to ignore the exception and handle it later or whether to handle the exception now.

Using the exception handling predicate register provides for much lighter weight exception processing. For example, an interrupt can be ignored or deferred if deemed less important thus saving valuable processor cycles. For example, no state save and restore cycles may be required. Also, the program has control over whether to handle exceptions or not.

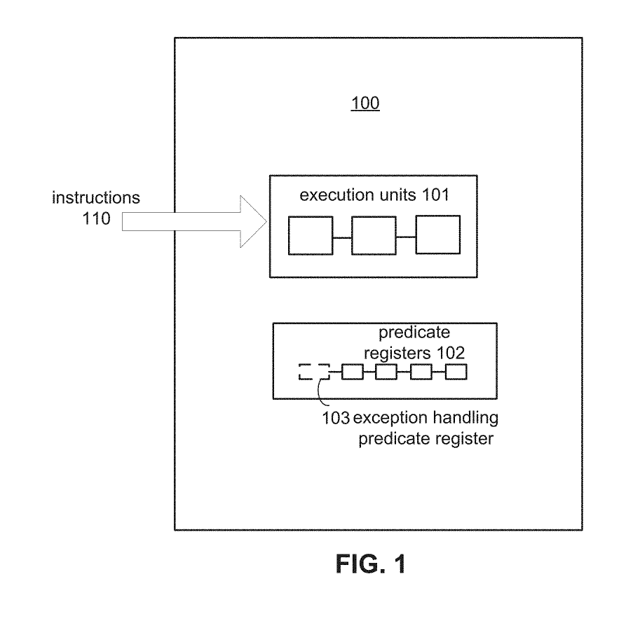

FIG. 1 illustrates a block diagram of a processor 100 according to an example. The processor 100 includes more components than shown. The components of the processor 100 that are shown are provided to illustrate use of exception handling predicate registers for exception handling.

The processor 100 is an integrated circuit that can execute machine readable instructions 110. The machine readable instructions 110 for example are instructions for a computer program and are referred to as instructions 110. Execution units 101 execute the instructions 110 at runtime for the computer program. The execution units 101 are hardware to perform the operations and calculations called for by the instructions 110. The execution units 101 may include integer units, floating point units, arithmetic logic units, multiply and divide units, etc. The execution units 101 may be part of a central processing unit in the processor 100.

The processor 100 has an architecture that supports predication and includes predicate registers 102. The instructions 110 may include predicated branch instructions, and the processor 100 executes the predicated branch instructions using the predicate registers 102. The predicate registers 102 store the predicates, which may include values indicating whether a condition for a predicated instruction evaluates to true or not. The execution units 101 execute predicated instructions, which are also represented by the instructions 110, and predicates for the predicated instructions are stored in the predicate registers 102. The stored predicates are used for conditional execution of the predicated instructions, such as to determine whether to write results of the predicated instructions or not.

According to an example, the processor 100 assigns at least one of the predicate registers 102 as an exception handling predicate register. Exception handling predicate register 103 is shown and may include one or a plurality of the predicate registers 102 that are assigned to be exception handling predicate registers. The exception handling predicate register 103 is shown in dashed line to represent that it is a predicate register assigned as an exception handling predicate register 103. The exception handling predicate register 103 stores an exception state for a detected exception instead of predicates for predicated instructions. For example, an execution unit may detect an exception. In response to detection of the exception, the processor 100 stores an exception state for the exception in the exception handling predicate register 103. The exception state indicates whether an exception is detected or not and may include additional information about the exception. The exception state may indicate that an exception has been detected, such as by storing a “1” if it is a single-bit register. Then, the processor 100 may determine how to handle the exception. For example, the computer program comprised of the instructions 110 may include instructions for handling the exception, and may decide to ignore the exception or handle it once it is detected. For example, the computer program may ignore or otherwise handle the exception, or may invoke an exception handler outside the computer program to handle the exception. The exception handler may include a service routine that is not part of the computer program and is for handling the exception. Different routines may be executed to resolve the exception depending on the type of exception that is detected.

The exception state may include additional information other than an indication of whether an exception is detected. For example, the exception state may indicate the type of exception that was detected. In one example, different exception handling predicate registers are for different types of exceptions, so depending on the exception handling predicate register that indicates an exception is detected, the computer program can determine the type of exception is detected. In another example, the value in a register may indicate the type of exception. Bindings may be stored or otherwise known that identify a particular exception handling predicate register or a particular value in an exception handling predicate register as corresponding to a particular type of exception. Depending on the type of exception, the computer program may handle the exception differently. When programming the computer program, a developer may include instructions on how to handle different types of exceptions. The exception state may include any information related to an exception and depending on the exception state and type of exception, different actions may be taken to handle the exception.

Exception handling using the exception handling predicate register 103 for example is part of the main instruction stream (e.g., instructions 110) and can be a fundamental attribute of the executing program. In other words, how to handle an exception is specified in the instructions of the computer program. The example below illustrates one style of computer programming to specify exception handling instructions. The instructions in the example may be part of the instructions 110:

```
  1. y = x % z ; // may trigger ″divide by zero″ exception
  2. a = b + c ;
  3. If (NOT pred[DIV_BY_ZERO]) goto
skip_div_by_zero_exception
  4. y = CONST1; // use default values for a and y if there is
an exception
  5. a = CONST2;
  6. pred[DIV_BY_ZERO] = 0; // clear exception status
  7. skip_div_by_zero_exception: // continue processing
```

In this example, instruction 1 may cause a divide by zero exception, which in turn causes an exception handling predicate register for the divide by zero exception to be set. Instruction 3 indicates that if the exception handling predicate register for divide by zero is not set (e.g., no divide by zero error), then goto instruction 7 and continue processing. If the exception handling predicate register for divide by zero is set, then use the default values for a and y, and clear the exception handling predicate register for divide by zero.

Below is another example of exception handling that may be provided in the computer program but the programming style is different than the example above. In this example, the instructions 3-5 are predicated instructions, and this example does not use GOTO to skip the divide by zero exception processing. Instead, the divide by zero exception processing is performed in instructions 3-5 if the predicate evaluates to true; i.e., if the exception handling predicate register for divide by zero is set.

```
  1. y = x % z; // may trigger ″divide by zero″ exception
  2. a = b + c ;
  3. If (pred[DIV_BY_ZERO]) then y = CONST1 ; // use
default values for a and y upon an exception
  4. If (pred[DIV_BY_ZERO]) then a = CONST2;  //
  5. If (pred[DIV_BY_ZERO]) then pred{DIV_BY_ZERO] = 0; //
clear exception status
  6. // continue processing
```

As indicated above, the exception handling predicate register 103 may include multiple exception handling predicate registers and different registers may be for different types of exceptions. According to an example, individual exceptions may be grouped together in one or more exception handling predicate registers. For example, two 16-bit exception handling predicate registers may be used to identify 32 different exceptions, where each bit represents a specific exception.

In one example, the exceptions that are handled locally by the computer program instead of being handled by an exception handler are ones that may happen frequently to lower overhead or it could be exceptions that would normally trigger an interrupt service routine and state saving, but they are ignored to minimize cycle penalties. For example, if a pipeline of execution units runs out of instructions it may typically trigger an exception but it may not matter for a particular computer program, so the computer program may ignore the exception at least temporarily.

Some examples of different types of exceptions may include floating point error, memory error, I/O error (e.g., file not found or disk full), overflow error for arithmetic operation, syntax error, etc. In one example, the processor 100 may set a particular exception handling predicate register corresponding to the type of exception. For example, assume the exception handling predicate register 103 includes 3 exception handling predicate registers. Bindings are stored that identify a first of the 3 exception handling predicate registers for a floating point exception, a second exception handling predicate register for an arithmetic operation exception, and a third exception handling predicate register for a memory error exception. Different components of the processor 100 or other components may detect these exceptions. Depending on the type of exception detected and the exception handling predicate register assigned to the exception as specified in the bindings, the processor 100 sets the corresponding exception handling predicate register.

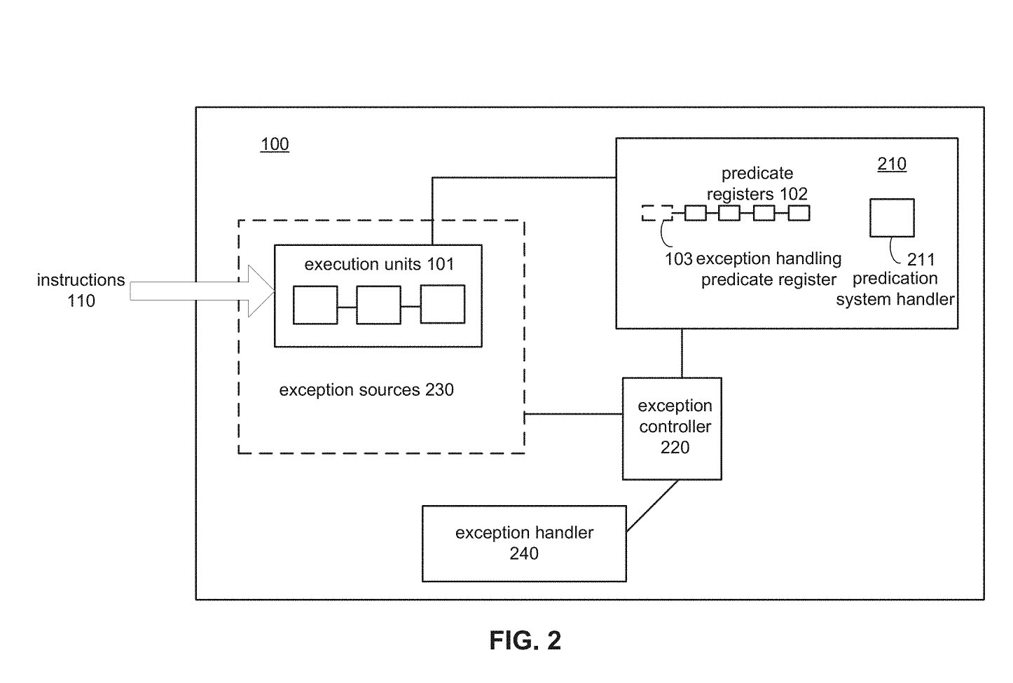

The processor 100 can also determine whether to invoke an exception handler, such as through an interrupt, or to set an exception handling predicate register in response to an exception being detected. For example, some exceptions may be handled in a conventional manner, such as by generating an interrupt to execute an interrupt service routine through the exception handler instead of setting an exception handling predicate register to have the computer program handle the exception. The processor 100 may determine whether to invoke the exception handler or set the exception handling predicate register based on the type of exception detected. This is further described with respect to FIG. 2.

FIG. 2 shows a diagram of the processor 100 according to another example. FIG. 2 shows more components of the processor 100, and the components may include hardware and blocks representing different operations that may be performed by the processor 100. For example, some of the blocks represent functionality that is made possible through the instruction set architecture executed by the processor 100. The components shown in FIG. 2 comprise a system for the processor 100. The system may include components external to the processor 100 and electrically connected to the processor 100. For example, a memory 200 including general registers may be connected to the processor 100 and/or other hardware components not shown but are commonly connected to a processor may be included in the system, such as I/O interfaces not shown for connection to networks, peripheral devices, etc. Also, the processor may be connected to a hard drive not shown. General purpose registers of the memory 200 may store any data for the computer program as opposed to the special purpose predicate registers 102 which may only store specific data, such as predicates or exception state.

As shown in FIG. 2, the processor 100 may include predication system 210 and exception controller 220. The exception controller 220 receives indication of a detected exception from exception sources 230. The exception sources 230 may determine that an exception has occurred. The exception sources 230 may include execution units 101 or other components that can detect various types of exceptions. For example, an arithmetic logic unit may detect an exception for an arithmetic operation, or a floating point unit may detect a divide by zero exception, or another source may detect a memory exception. The exception sources 230 may set flags or otherwise provide indication of detected exceptions to the exception controller 220. Depending on the exception detected, the exception controller 220 may invoke an exception handler 240 to handle the exception or invoke setting an exception handling predicate register to indicate the exception is detected. The exception handler 240 may include a routine, such as an interrupt service routine, to handle the exception. The routine may be outside the computer program which is being executed by the execution units 101.

The exception controller 220 may determine whether to invoke the exception handler 240 or set the exception handling predicate register depending on the type of exception is detected. In one example, the exception sources 230 may send interrupts in response to detecting exceptions. The exception controller 220 may include logic, such as multiplexors, etc., to output the interrupt to either the predication system 210 or the exception handler 240. The exception controller 220 may be programmed to send interrupts from particular sources to the predication system 210 and interrupts from other sources to the exception handler 240. Accordingly, depending on the source (or the type of exception detected by the source), the interrupt is output to the predication system 210 or the exception handler 240.

The predication system 210 receives the interrupt and sets the exception handling predicate register to indicate the exception is detected. Setting an exception handling predicate register includes storing the exception state that indicates the exception is detected. Clearing the exception handling predicate register clears the exception state, such as to indicate that currently no exception is detected. The predication system 210 may include a predication system handler 211 implementing native instructions from the instruction set for the predicate registers 102. For example, the instruction set architecture for the processor 100 includes native instructions for managing the predicate registers 102, including the exception handling predicate register 103. The native instructions include instructions for setting and clearing the predicate registers 102, including the exception handling predicate register 103. The predication system handler 211 implements these native instructions to perform these functions.

The predication system handler 211 may store bindings to associate each of a plurality of exception handling predicate registers with a particular exception type. Depending on the exception type that is detected, the predication system handler 211 sets the corresponding exception handling predicate register as indicated by the bindings. The exception handling predicate registers may be cleared by the predication system handler 211.

The processor 100 supports the ability of the computer program working with predication system handler 211 to subsequently and explicitly trigger the exception handler 240. This may happen if the exception state does not match criteria in the computer program. For example, assume a BUS EXCEPTION has associated states of PARITY_ERROR, TIMEOUT, and INVALID_ADDRESS. The computer program utilizing the predication system handler 211 can handle the latter two conditions but defers to a standard interrupt exception mechanism, which may be provided by exception handler 240, for PARITY_ERROR. Also, the specific exceptions that are subject to control may vary during course of execution from “0” to “many”.

Furthermore, the processor 100 can handle nested functions that may have different exception criteria. The nested functions are also referred to as hierarchal functions because one function may invoke the other. The functions specify which function in the hierarchy is to handle a particular exception. For example, the instructions 110, which may include a main instruction stream executed by the execution units 101, include two functions F1 and F2 that trap exceptions X1-X3 as follows:

F1: X1, X2; and

F2: X2, X3.

During the course of execution of the instructions 110, F1 invokes F2 several times. If exception X3 happens in the scope of execution of F1, but not F2, the standard interrupt service routine may be invoked. If exception X1 happens in the scope of execution of F2, the instructions for F2 ignore X1 until returning to F1. If exception X2 happens in the scope of execution of F2, then the instructions specify the following possibilities: the exception is examined and fully handled within the scope of F2, and invisible to F1; the exception is examined and partially handled within the scope of F2, and then evaluated again by F1; or the exception is examined and not handled within the scope of F2, and then evaluated again by F1. Thus, as illustrated by this example, the programmer is able to specify the exception criteria and exception handling for hierarchal functions.

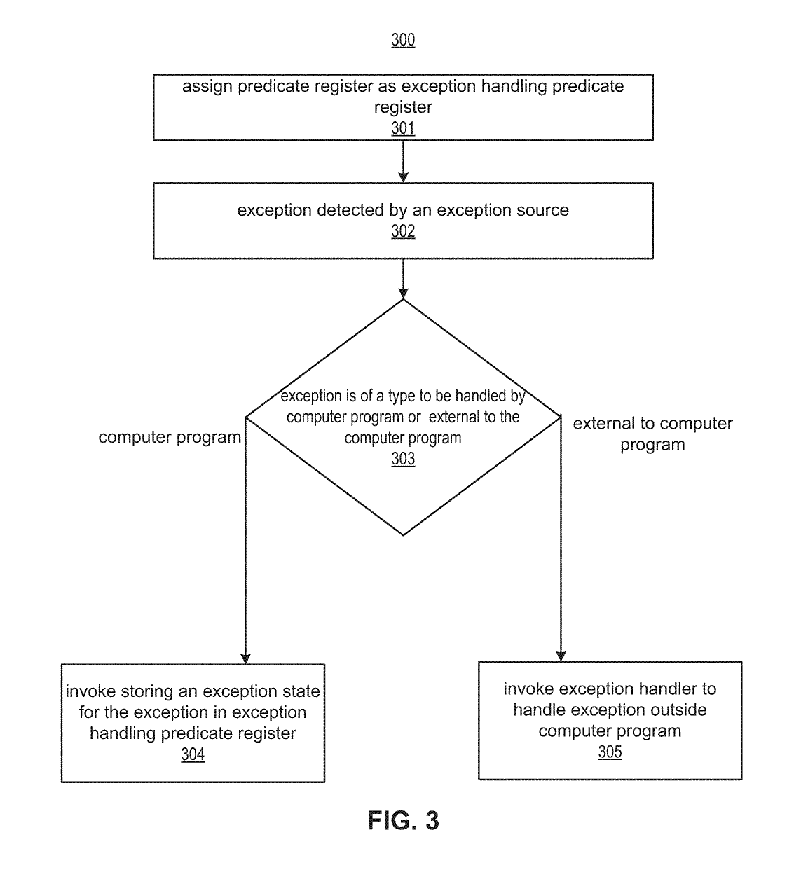

FIG. 3 illustrates a method 300 according to an example. The method 300 is described as being implemented by the processor 100, such as shown in FIGS. 1 and 2, but may be implemented by other systems.

At 301, a predicate register of the predicate registers 102 is assigned as the exception handling predicate register 103. One or multiple exception handling predicate registers may be created by assigning one or multiple predicate registers to be exception handling predicate registers. Assigning predicate registers to be exception handling predicate registers may be performed dynamically by a computer program at runtime or may be predetermined prior to runtime.

At 302, an exception is detected by an exception source, such as one of the exception sources 230. For example, an arithmetic logic unit may detect an exception for an arithmetic operation, or a floating point unit may detect a divide by zero error, or another source may detect a memory error. The exception sources 230 may set flags or otherwise provide indication of detected exceptions to the exception controller 220, such as through interrupts.

At 303, the exception controller 220 determines whether the exception is of a type to be handled by the computer program or to be handled external to the computer program, such as by the exception handler 240. The determination may be made based on type of exception detected, and the exception controller 220 may include logic that invokes the setting of an exception handling predicate register for certain types of exceptions and invokes the exception handler 240 for other types of exceptions.

At 304, in response to the exception being of a type to be handled by the computer program, the exception controller 220 invokes storing an exception state for the exception in the exception handling predicate register 102. For example, the exception controller 220 sends a signal to the predication system 210 to set the exception handling predicate register 102.

At 305, in response to the exception being of a type not to be handled by the computer program, the exception controller 220 invokes the exception handler 240 to handle the exception outside the computer program. For example, the exception handler 240 runs a routine to handle the exception.

While embodiments of the present disclosure have been described with reference to examples, those skilled in the art will be able to make various modifications to the described embodiments without departing from the scope of the claimed embodiments.

What is claimed is:

1. A processor comprising:
execution units to execute machine readable instructions for a computer program;
a plurality of predicate registers; and
the processor is to
assign a predicate register of the plurality of predicate registers as an exception handling predicate register;
detect an exception when executing the machine readable instructions; and
store an exception state for the exception in the exception handling predicate register.

2. The processor of claim 1, wherein to store the exception state, the processor is to:
determine a type of the detected exception; and
determine whether to store the exception state in the exception handling predicate register based on the type.

3. The processor of claim 2, wherein the processor is to store the exception state in the exception handling predicate register in response to determining the exception is of a type to be handled by the computer program; and
the processor is to invoke an exception handler in response to determining the exception is of a type to be handled outside the computer program.

4. The processor of claim 2, wherein the processor is to assign a plurality of the predicate registers as exception handling predicate registers, and each exception handling predicate register stores an exception state for a particular type of exception, and wherein
the computer program is to determine the type of exception detected according to the exception handling predicate register storing the exception state.

5. The processor of claim 1, wherein the predicate register is dynamically assigned as the exception handling predicate register according to the computer program, and the assignment of the predicate register as the exception handling predicate register is removed by the computer program or in response to the computer program completing execution.

6. The processor of claim 1, wherein the predicate register is dedicated as the exception handling predicate register for any computer program executed by the execution units.

7. The processor of claim 1, wherein the machine readable instructions comprise a plurality of hierarchal functions, and the functions specify exception handling criteria for determining whether to handle exceptions locally by each function and specify which functions are to handle a particular exception when the particular exception is to be handled locally by one of the functions.

8. A system comprising:
execution units to execute machine readable instructions for a computer program;
a predication system including
a plurality of predicate registers, wherein at least one of the predicate registers is assigned as an exception handling predicate register, and
a predicate system handler to set and clear the exception handling predicate register according to instructions in an instruction set for the processor; and
an exception controller to determine whether an exception detected when executing the computer program is to invoke setting an exception state in the exception handling predicate register, or invoke the predication system to set the exception state in the exception handling predicate register.

9. The system of claim 8, wherein the predication system is to store bindings identifying the at least one predicate register as the exception handling predicate register, and the predication system does not use the exception handling predicate register to store predicates unrelated to exceptions for predicated instructions in the computer program.

10. The system of claim 8, wherein the exception handling predicate register comprises a plurality of exception handling predicate registers, and the bindings identify a plurality of types of exceptions and an exception handling predicate register id to store the exception state for each type of exception.

11. The system of claim 8, wherein the at least one predicate register is dynamically assigned as the exception handling predicate register by the predication system according to the computer program, and the assignment is no longer valid after execution of the computer program.

12. The system of claim 8, wherein the at least one predicate register is dedicated as the exception handling predicate register by the predication system and operates as the exception handling predicate register for any computer program executed by the execution units.

13. The system of claim 8, wherein the predication system is to receive an instruction to clear the exception state from the exception handling predicate register and clear the exception handling predicate register in response to the instruction.

14. The system of claim 8, wherein in response to determining the detected exception is not to cause the setting of the exception state in the exception handling predicate register, the exception controller is to invoke an interrupt to handle the exception.

15. A method comprising:
assigning a predicate register of a plurality of predicate registers as an exception handling predicate register;
detecting an exception when executing machine readable instructions for a computer program; and
determining whether the exception is of a type to be handled by the computer program;
in response to determining the exception is of the type to be handled by the computer program, storing an exception state for the exception in the exception handling predicate register; and
in response to determining the exception is of a type not to be handled by the computer program, invoking an exception handler to handle the exception outside the computer program.
